(19) United States
(12) Patent Application Publication
(10) Pub. No.: US 2021/0341104 A1
(43) Pub. Date: Nov. 4, 2021

(54) METHOD AND DEVICE FOR CONTROLLING GAS CONSUMERS

(71) Applicant: TRUMA GERÄTETECHNIK GMBH & CO. KG, Putzbrunn (DE)

(72) Inventors: Alexander KIRCHBERGER, Putzbrunn (DE); Nils MAHR, Putzbrunn (DE); Michael MAIER, Putzbrunn (DE); Alin POSTU, Putzbrunn (DE); Lars ZIMMERMANN, Putzbrunn (DE)

(21) Appl. No.: 17/283,096

(22) PCT Filed: Sep. 26, 2019
(86) PCT No.: PCT/EP2019/076112

§ 371 Date: Apr. 6, 2021

(30) Foreign Application Priority Data
Oct. 10, 2018 (DE) 10 2018 007 980.6

(51) Int. Cl. F17C 7/02

(52) U.S. Cl. CPC F17C 7/02; F17C 2221/035; F17C 2250/0636; F17C 2250/0439; F17C 2250/032

(57) ABSTRACT

The invention relates to a method for controlling a plurality of gas consumers (20, 21), comprising the following steps: assigning priorities to the gas consumers (20, 21), and activating or deactivating the gas consumers (20, 21) as a function of the priorities assigned. The invention further relates to a control device (1) for controlling gas consumers (20, 21).

The invention relates to a method of controlling a plurality of gas consumers. The invention further relates to a control device for controlling a plurality of gas consumers.

It is known in the prior art to use combustible gas (e.g. propane or butane in the form of liquefied petroleum gas (LPG) as an energy source. It is used, for example, to operate stoves, heating systems or water heaters.

When gas consumers are applied in particular in mobile spatial units, such as those given by caravans, motor homes or boats, there are in some cases legal specifications that prescribe a maximum permissible total consumption for the connected devices of a gas system. Therefore, it is common practice to specify a nominal gas consumption per hour for gas consumers.

The object of the invention is to propose a method and a device for controlling gas consumers, which ensure that a maximum permissible gas consumption value in a system is not exceeded.

The invention achieves the object with a method of controlling a plurality of gas consumers, the method comprising at least the steps of:
Priorities are assigned to the gas consumers.
The gas consumers are activated or deactivated as a function of the priorities assigned.

The control method according to the invention thus consists in assigning priorities to the different gas consumers that are present in the gas system. The priorities correspond to different degrees of importance of the gas consumers for the gas system itself or for the user of the system. It may be provided here that different gas consumers are assigned the same priority. Based on the priorities, the gas consumers are activated (that is, started) or deactivated (that is, switched off) in the control process.

The invention allows any desired number of gas consumers to be installed in a system, since their operation is controlled. In one configuration, the priorities are dedicated to the devices or gas consumers. Alternatively or additionally, the priorities are assigned to the gas consumers in a particular application.

One configuration of the method provides that the gas consumers are activated or deactivated as a function of a specifiable maximum value for a gas consumption. The maximum value of the gas system to which the gas consumers are assigned results, for example, from a standard. For example, a maximum value of 1.5 kg of gas per hour in accordance with DIN EN 1949 may be mentioned. In the method, it is ensured in particular that the maximum value is not exceeded. This is done, for example, on the basis of known nominal gas consumption quantities of the gas consumers or by specifying permissible gas consumption quantities for the activated gas consumers. In particular, if the gas consumption quantities of a plurality of gas consumers collectively exceed the maximum value, the gas consumers will not be activated.

According to one configuration, the gas consumers are activated or deactivated depending on previously known or ascertained gas consumption data. For example, the gas consumption data are the previously known nominal gas consumption quantities of the gas consumers. Alternatively, the gas consumption quantities of the activated gas consumers are measured.

In one configuration of the method, it is provided that the gas consumers are activated with a maximum permissible gas consumption quantity being specified. In this configuration, the respectively permissible consumption quantities are allocated to the gas consumers.

One configuration of the method consists in that gas consumers having higher priorities are activated before gas consumers having lower priorities.

One configuration of the method provides that gas consumers having the same priority are activated simultaneously such that a permissible gas consumption quantity is divided up among the gas consumers having the same priority. In this configuration, if at least two gas consumers have the same priority, the gas consumers are operated in parallel, with the permissible gas consumption quantity being distributed to the individual gas consumers. Some of the gas quantities available to the individual gas consumers are fixedly specified or can be assigned individually.

One configuration of the method consists in that an activated gas consumer is deactivated when a setpoint value to be reached by the activated gas consumer has been reached. The configuration concerns the fact that gas consumers each have to reach at least one setpoint value. For a heater, for example, this is a room temperature, or for a water heater, this is the temperature of the water. In this configuration, an activated gas consumer is deactivated when the setpoint value it has to reach has been reached. Thus, for example, when the desired room temperature has been attained, the heater—as an example of a gas consumer—is deactivated.

One configuration of the method provides that after deactivating an activated gas consumer, a gas consumer is activated that has a lower priority than the deactivated gas consumer.

One configuration of the method consists in that the setpoint value of a deactivated gas consumer is monitored. In the event that a change in the setpoint value has been detected and a gas consumer having a lower priority than the deactivated gas consumer is activated, in one configuration the activated gas consumer is deactivated and the deactivated gas consumer is activated. In an alternative configuration, in this case the deactivated gas consumer is activated after the activated gas consumer has been deactivated after reaching a setpoint value to be reached by the activated gas consumer.

In the above-mentioned configurations, a setpoint value that has been reached by a gas consumer is monitored. For example, if the setpoint value is a desired room temperature that has been produced by a heater, the room temperature is monitored by a thermometer. The following configurations relate to what happens when it is detected that the setpoint value is no longer given while a gas consumer that is subordinate in terms of priority is active. One configuration consists in that the gas consumer having the lower priority is deactivated and the gas consumer having the higher priority and showing the deviation from the setpoint value is activated in its place. In an alternative configuration, when the currently activated gas consumer has reached its setpoint value and, as a result, has been deactivated, the gas consumer having the higher priority is reactivated—preferably immediately afterwards. Thus, in this way a possible sequence of the gas consumers is interrupted in order to reactivate the gas consumer that had already been deactivated earlier.

Furthermore, the invention relates to a software or a software program serving to implement the method, as well as to a data carrier carrying such a program.

The invention further achieves the object by a control device for controlling a plurality of gas consumers, the control device including at least one output interface, the control device outputting control data for the gas consumers via the output interface, and the control device generating the control data based on priorities assigned to the gas consumers. Here, the control data relate to the activation or deactivation of gas consumers or else to the respective assigned gas consumption quantities.

According to one configuration, the control device is configured to carry out the method according to any of the aforementioned or following configurations. In this respect, the associated discussions correspondingly apply to the control device as well.

One configuration consists in that the control device includes at least one input interface for receiving sensor data. Alternatively or additionally, provision is made for the control device to include a data storage for storing data. As an alternative or in addition, the control device includes an input device for inputting data.

In detail, there is a multitude of options to configure and further develop the method or the device. In this regard, reference is made, for one thing, to the claims subordinate to the independent claims, and, for another, to the following description of exemplary embodiments in conjunction with the drawing, in which:

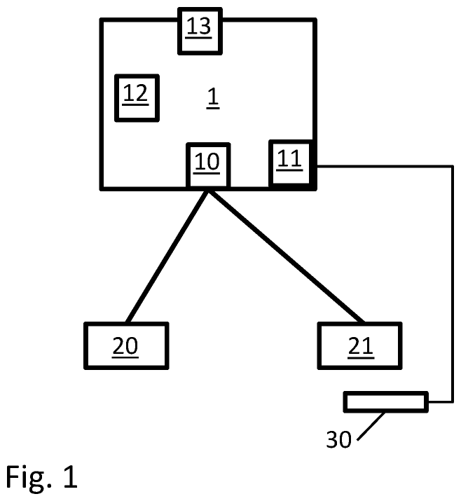

FIG. 1 shows a schematic illustration of a system with a device for controlling gas consumers and a plurality of gas consumers.

FIG. 1 shows, purely schematically, a system in which, by way of example, two gas consumers 20, 21 are controlled by a shared control device 1.

As an example, the gas consumers 20, 21 here are a water heater 20 and a heater 21. In order to perform their functions, the gas consumers 20, 21 consume combustible gas (e.g. propane or butane); a maximum and, where applicable, legally specified gas quantity per unit of time must not be exceeded.

For the control device 1 to control the gas consumers 20, 21, a priority is assigned to each gas consumer in a first step. In one variant, this is preceded by the step of making the connected gas consumers 20, 21 and/or the gas consumers 20, 21 to be controlled known to the control device 1.

The priorities may be fixed, e.g. predefined by the type of gas consumer, or they may be specified for each current case. For example, during the summer, the heating unit may be given a lower priority than in winter. The priorities are specified here via the input device 13 and by storing them in the data storage 12. Moreover, the setpoint values to be reached by the gas consumers 20, 21 are also specified here by means of the input device 13.

A sensor 30—here in the form of a thermometer for determining the room temperature—is provided to detect that a setpoint value has been reached and, based on this, to deactivate a gas consumer. The sensor signal is supplied to the control device 1 via an input interface 11.

For activating or deactivating the gas consumers 20, 21, the output interface 10 is provided, by means of which the control device 1 outputs appropriate control data to the gas consumers 20, 21.

While some aspects have been described in connection with a device, it will be appreciated that these aspects also constitute a description of the corresponding method. By analogy, aspects that have been described in connection with or as a method step also represent a description of a corresponding block or details of a corresponding device. Depending on specific implementation requirements, exemplary embodiments of the invention may be implemented in hardware or in software. That is, some exemplary embodiments according to the invention comprise a data carrier which contains electronically readable control signals adapted to interact with a programmable computer system in such a way as to carry out any of the methods described herein.

### LIST OF REFERENCE NUMBERS

1 control device
10 output interface
11 input interface
12 data storage
13 input device
20 water heater
21 heater
30 sensor

1. (canceled)

2. (canceled)

3. (canceled)

4. (canceled)

5. (canceled)

6. (canceled)

7. (canceled)

8. (canceled)

9. (canceled)

10. A method of controlling a plurality of gas consumers, the method comprising at least the steps of:
assigning priorities to the gas consumers, and
activating or deactivating the gas consumers as a function of the priorities assigned,
characterized in that
the gas consumers are activated or deactivated as a function of a specifiable maximum value for a gas consumption,
that an activated gas consumer is deactivated when a setpoint value to be reached by the activated gas consumer has been reached,
that after deactivating a gas consumer, a gas consumer is activated that has a lower priority than the deactivated gas consumer,
that the setpoint value is monitored, and
that in the event that a change in the setpoint value has been detected and a gas consumer having a lower priority than the deactivated gas consumer is activated, either the deactivated gas consumer is activated after the activated gas consumer has been deactivated after reaching a setpoint value to be reached by the activated gas consumer, or
the activated gas consumer is deactivated and the deactivated gas consumer is activated.

11. A control device for controlling a plurality of gas consumers,
wherein the control device includes at least one output interface,
wherein the control device outputs control data for the gas consumers via the output interface,
wherein the control device generates the control data based on priorities assigned to the gas consumers, and
wherein the control device is configured to carry out the method according to claim 10.
